(19) United States
(12) Patent Application Publication
(10) Pub. No.: US 2009/0016246 A1
(43) Pub. Date: Jan. 15, 2009

(54) METHOD AND APPARATUS FOR DATA TRANSMISSION IN AN UNLICENSED MOBILE ACCESS NETWORK

(75) Inventors: Robert D. Battin, Kildeer, IL (US); Moon Do Seo, Hoffman Estates, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/776,772

(22) Filed: Jul. 12, 2007

(51) Int. Cl. H04Q 7/00

(52) U.S. Cl. 370/310

(57) ABSTRACT

A method and wireless device are provided for at least one of transmitting and receiving data over an unlicensed mobile access network. The method comprises establishing a connection with an unlicensed mobile access network (104). Data from a user to be transmitted over the unlicensed mobile access network (104) is received. At least one IPsec packet including the data received from the user (108). The IPsec packet is encapsulated within a network language protocol (1010). The encapsulated IPsec packet (502) is transmitted to an unlicensed mobile access network network controller (116) within the unlicensed mobile access network (104).

### FIELD OF THE INVENTION

The present invention generally relates to the field of wireless communication systems, and more particularly relates to unlicensed mobile access networks.

### BACKGROUND OF THE INVENTION

Unlicensed Mobile Access (“UMA”) is a technology that provides a dual mode wireless device access to wide area networks and local area networks via licensed and unlicensed spectrum technologies. UMA has been standardized in 3GPP as TS (“Technical Specification”) 43.318 Generic access to the A/Gb interface (“GAN”). Current UMA systems use IP security protocols (“IPSec”) to authenticate and encrypt messages for wide area network, e.g., Global System for Mobile Communications (“GSM”) voice and data call applications provided over an Internet Protocol (“IP”) broadband interface. The typical usage of UMA is for residential broadband coverage with Wireless Local Area Network (“WLAN”) over a Digital Subscriber Line (“DSL”) or cable broadband access network. In UMA systems, the UMA client or handset device creates a GSM voice frame, the GSM voice frame is encapsulated in a RTP/UDP/IP datagram and then encrypted and encapsulated into an IPsec ESP/IP datagram for delivery to a Packet Data Gateway (“PDG”) or a Security Gateway of a UMA network controller (“UNC”) over the broadband IP network (Up interface). The PDG terminates the IPsec protocol by decrypting it, un-encapsulating the RTP/UDP/IP datagram, and then delivering the RTP/UDP/IP datagram to the UNC.

However, UMA systems are generally only suitable for residential users. This is because residential users typically do not utilize sophisticated firewalls such as those used in enterprise networks. In enterprise networks, UMA becomes problematic because most enterprise grade firewalls use access control to block IPsec packets for outbound traffic. These firewalls are configured to only allow certain traffic to pass based on a port addresses called open ports. One solution to this problem has been to take advantage of the existing open port used for Hyper Text Transfer Protocol (“HTTP”) (80) or HTTP over Secure Socket Layer (“HTTPS”) (443). Payload is sent within Transmission Control Protocol (“TCP”) packets using these open ports. However, this solution is also problematic because firewall vendors now provide deep packet inspection to insure traffic sent on well-known ports conforms to the protocol designated for that port. Therefore embedding UMA protocols within TCP packets on the opens ports is not a suitable solution.

Therefore a need exists to overcome the problems with the prior art as discussed above.

### SUMMARY OF THE INVENTION

Briefly, in accordance with the present invention, disclosed is a method and wireless communication device for at least one of transmitting and receiving data over an unlicensed mobile access network. The method comprises establishing a connection with an unlicensed mobile access network. Data from a user to be transmitted over the unlicensed mobile access network is received. At least one IPsec packet including the data is received from the user. The IPsec packet is encapsulated within a network language protocol. The encapsulated IPsec packet is transmitted to an unlicensed network controller within the unlicensed mobile access network.

In another embodiment, a method, with an information processing system, for managing IPsec packets within an unlicensed mobile access network is disclosed. The method includes receiving an encapsulated IPsec packet from a wireless communication device. The IPsec packet is encapsulated within a network language protocol. The encapsulated IPsec packet is transformed into its original form. Data from the IPsec packet is retrieved in its original form.

In yet another embodiment, a wireless communication device is disclosed. The wireless communication device comprises a memory and a processor that is communicatively coupled to the memory. The wireless communication device also includes an unlicensed mobile access network communication module that is communicatively coupled to the memory and the processor. The unlicensed mobile access network communication module is adapted to establishing a connection with an unlicensed mobile access network. Data from a user to be transmitted over the unlicensed mobile access network is received. At least one IPsec packet including the data received from the user. The IPsec packet is encapsulated within a network language protocol. The encapsulated IPsec packet is transmitted to an unlicensed network controller within the unlicensed mobile access network.

### BRIEF DESCRIPTION OF THE DRAWINGS

The accompanying figures where like reference numerals refer to identical or functionally similar components throughout the separate views, and which together with the detailed description below are incorporated in and form part of the specification, serve to further illustrate various embodiments and to explain various principles and advantages all in accordance with the present invention.

FIG. 1 is a block diagram illustrating a wireless communication system according to an embodiment of the present invention;

FIG. 2 is a signal flow diagram illustrating a transmission of an IPsec packet by the wireless communication device of FIG. 1 to the UMA Network Controller (“UNC”) of FIG. 1 according to an embodiment of the present invention;

FIG. 3 is a signal flow diagram illustrating a transmission of an IPsec packet in an Unlicensed Mobile Access (“UMA”) network of the prior art;

FIG. 4 is a block diagram illustrating an IPsec packet encapsulated within an HTTP protocol according to an embodiment of the present invention;

FIG. 5 is a signal flow diagram illustrating a transmission of IPsec data by the wireless communication device of FIG. 1 to the UNC of FIG. 1 using HTTP POST request according to an embodiment of the present invention;

FIG. 6 is a block diagram of the wireless communication device of FIG. 1 according to an embodiment of the present invention;

FIG. 7 is a block diagram illustrating a information processing system according to an embodiment of the present invention;

FIG. 8 is a logic flow diagram illustrating an exemplary process of transmitting network language protocol encoded IPsec packets according to an embodiment of the present invention;

FIG. 9 is a logic flow diagram illustrating an exemplary process of receiving a network language protocol encoded IPsec packet at a UNC in a UMA network according to an embodiment of the present invention;

FIG. 10 is a logic flow diagram illustrating a process whereby the wireless communication device of FIG. 1 transmits network language protocol encoded IPsec packets according to an embodiment of the present invention;

FIG. 11 is a logic flow diagram illustrating a process of whereby the UNC of FIG. 1 receives a network language protocol encoded IPsec packet according to an embodiment of the present invention;

FIG. 12 is a logic flow diagram illustrating a process whereby the UNC of FIG. 1 transmits network language protocol encoded IPsec packets according to an embodiment of the present invention; and

FIG. 13 is a logic flow diagram illustrating a process whereby the wireless communication device of FIG. 1 receives a network language protocol encoded IPsec packet according to an embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The term wireless communication device is intended to broadly cover many different types of devices that can wirelessly receive signals, and optionally can wirelessly transmit signals, and may also operate in a wireless communication system. For example, and not for any limitation, a wireless communication device can include any one or a combination of the following: a cellular telephone, a mobile phone, a smartphone, a two-way radio, a two-way pager, a wireless messaging device, a laptop/computer, automotive gateway, residential gateway, and the like.

One of the advantages of the present invention is that it provides an advantageous system wherein a wireless communication device within a Unlicensed Mobile Access (“UMA”) network can send an IP security protocol (“IPsec”) packet to the UNC. IPsec packets can be sent by a wireless communication device to a UMA Network Controller (“UNC”) by encapsulating the IPsec packets within a network language protocol such as the Hyper Text Transfer Protocol (“HTTP”). This allows the IPsec to pass through a firewall that blocks IPsec packets and provides deep packet inspection to insure traffic sent on well-known ports conforms to the protocol designated for that port.

Wireless Communication System

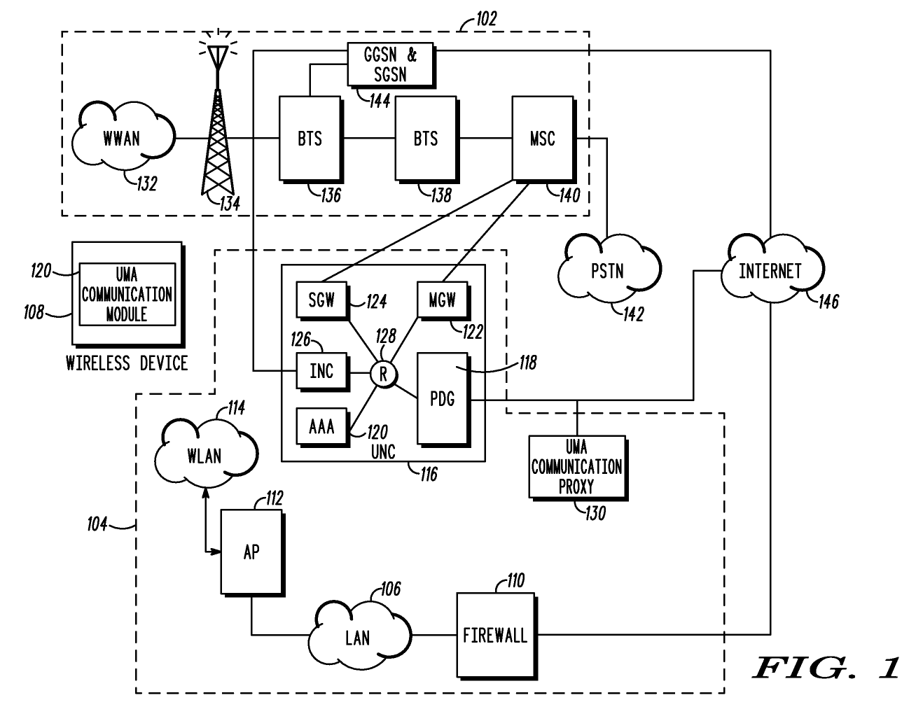

According to an embodiment of the present invention, as shown in FIG. 1, an exemplary wireless communication system 100 is illustrated. FIG. 1 shows the wireless communication system 100 comprising a circuit services network 102, such as a GSM network, and an Unlicensed Mobile Access (“UMA”) network 104. It should be noted that the present invention is not limited to a GSM network, which has been used only as an example. Other wireless communication standards such as Code Division Multiple Access (“CDMA”), Time Division Multiple Access (“TDMA”), General Packet Radio Service (“GPRS”), Frequency Division Multiple Access (“FDMA”), Orthogonal Frequency Division Multiplexing (“OFDM”), or the like are also applicable to the present invention.

UMA or Generic Access Network (“GAN”) enables access to mobile voice, data, and IP Multimedia Subsystem (“IMS”) services over Internet Protocol (“IP”) broadband access and unlicensed spectrum technologies such as Wireless Fidelity (“Wi-Fi”). Consequently, UMA describes a telecommunication network that allows seamless roaming and handover between Wireless Local Area Networks (“WLAN”) and Wide Area Networks (“WAN”) using dual mode communication devices. The WLAN, for instance, can be based on private unlicensed spectrum technologies, for example, Bluetooth, Wi-Fi, 802.11, infrared, or the like. The WAN on the other hand can be based on, for example, GSM, CDMA, GPRS, TDMA, FDMA, OFDM, or the like. UMA is therefore, an attempt towards convergence of mobile, fixed and Internet telephony.

The wireless communications system 100 includes at least one wireless communication device 108 (one shown) serviced by the circuit services network 102. In one embodiment, the wireless communication device 108 is a dual mode device capable of communicating on a wide area network such as the GSM network 102 and a local area network such as the UMA network 104. The wireless communication device 108 also includes a UMA communication module 120 for communicating with the UMA network 104. The dual mode capabilities of the wireless communication device 108 allows it to selectively switch between WLANs and WANs to communicate with other users and access other services The UMA communication module 120 is discussed in greater detail below.

In one embodiment, the UMA network 104 comprises a firewall 110 and an access point 112; however, when the UMA network 104 is a residential network then the network might not include the firewall. The firewall 110 intercepts incoming and outgoing data traffic to the UMA network 104 and either allows or denies the traffic according to various security policies. The UMA network 104 comprises a Wireless Local Area Network (“WLAN”) and the access point 112 provides wireless communication services to the wireless communication device 108 via a WLAN air interface 114. The UMA network 104 and corresponding air interface 114, in one embodiment, provides data connections at much higher transfer rates than a traditional circuit services network. The UMA network 104 and corresponding air interface 114, in various embodiments, may comprise an Evolution Data Only (“EV-DO”) network, a General Packet Radio Service (“GPRS”) network, a Universal Mobile Telecommunications System (“UMTS”) network, an 802.11 network, an 802.16 (WiMax) network, or the like. A local area network (“LAN”) 106 communicatively couples the access point 112 with the firewall 110.

The UMA network 104 also includes a UMA network controller (“UNC”) 116. The UNC 116 couples an existing wide area network, such as the GSM network 102, and an existing packet data network to the access point 112. In other words, the UNC 116 connects to a public IP network such as the Internet 146 and to the core mobile network using industry standard interfaces. The UNC 116 manages subscriber access to mobile voice and data services from the various WLAN locations. Generally, the UMA network 104 is within a residential network or an enterprise network within a user's home or situated in the customer site. As discussed above, the wireless communication device 108 is a dual mode device and upon entering the UMA network 104, the wireless communication device establishes an IPsec tunnel through the UMA network 104 to the UNC 116.

The UNC 116, in one embodiment, includes a UMA security gateway or Packet Data Gateway (“PDG”) 118. The PDG 118 terminates the IP network connection and decrypts incoming traffic received at the UNC 116. The PDG 118 also authenticates the wireless communication device 108 based on various information such as location, subscriber profile information, activity status information, and the like. One or more of these information sets can be provided by an Authentication, Authorization, Accounting server (“AAA”) 120. The UNC 116 also includes a Media Gateway (“MGW”) 122 and a Signalling Gateway (“SGW”) 124, which provide translation between IP and circuit switched networks.

An IP Network Controller (“INC”) 126 is also included in the UNC 116. The INC 126 provides management of security over the UMA network 104, control of packet mode and circuit-mode services, signaling interface processing, control of the MGW 122, and other functions that are known to one of ordinary skill in the art. In one embodiment, a router 128 communicatively couples UNC components 118, 120, 122, 124, and 126 to one another within the UNC 116. It should be noted that the above discussion for the UNC 116 illustrates only one example of a UNC configuration. One or more of the components discussed above can be removed from the UNC 116 and one or more additional components can be added to the UNC 116.

The UMA network 104, in one embodiment, also includes a UMA communication proxy 130, which is discussed in greater detail below. It should be noted that although FIG. 1 shows the UMA communication proxy 130 residing outside of the UNC 116, the UMA communication proxy 130 can reside within the UNC 116 as a separate component or can reside within a component, such as the PDG 118, within the UNC 116.

The circuit services network 102 (a GSM network in the example of FIG. 1) provides, among other things, voice services to the wireless communication device 108. The circuit services network 102 preferably comprises a Wireless Wide Area Network (“WWAN”) that includes a WWAN air interface 132. The circuit services network 102 includes a base transceiver station 136 (“BTS”) that is communicatively coupled to an antenna 134 and to a base station controller (“BSC”) 138. The BSC 138 controls and manages a set of BTSs and is communicatively coupled to a mobile switching center (“MSC”) 140. The MSC 140 provides various services such as GSM services, circuit-switch calling, and the like to wireless devices roaming within the area that the MSC 140 serves.

The MSC 140, in one embodiment, communicatively couples the wireless communication device 108 to a Public Switched Telephone Network (“PSTN”) 142. The circuit services network 102 also includes a Gateway GPRS Support Node/Serving GPRS Support Node (“GGSN/SGSN”) 144. In one embodiment, the GGSN provides connectivity to the SGSN and to an IP network such as the Internet 146 and detunnels user data from GPRS Tunneling Protocol. The SGSN establishes the Packet Data Protocol with the GGSN and implements packet scheduling policies.

The circuit services network 102 and the UMA network 104 can each comprise a mobile text messaging device network, a pager network, or the like. Text messaging standards such as Short Message Service (“SMS”), Enhanced Messaging Service (“EMS”), Multimedia Messaging Service (“MMS”), and the like are also included in the networks 102, 104. The circuit services network 102 and the UMA networks 104 can support any number of wireless communication devices 108. The support of the networks 102 and 104 includes support for mobile telephones, smart phones, text messaging devices, handheld computers, wireless communication cards, pagers, beepers, or the like. A smart phone is a combination of 1) a pocket PC, handheld PC, palm top PC, or Personal Digital Assistant (“PDA”), and 2) a mobile telephone. More generally, a smartphone can be a mobile telephone that has additional application processing capabilities.

Enterprise Unlicensed Mobile Access

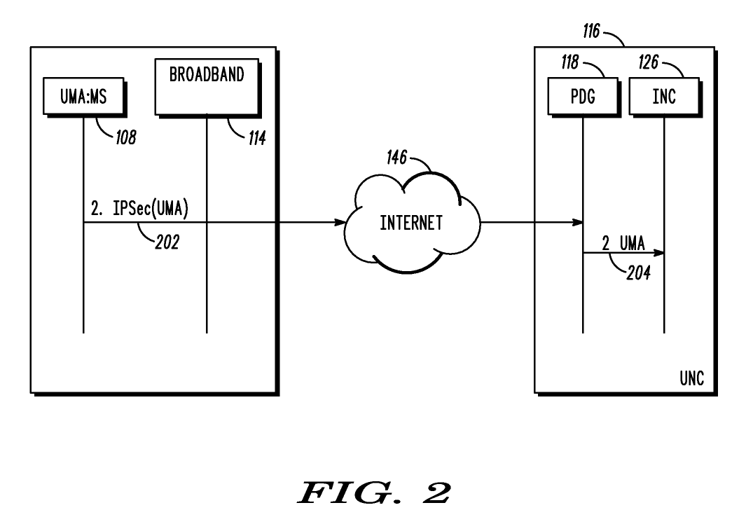

As discussed above, when a wireless communication device 108 enters a UMA network 104 it establishes an IPsec tunnel through the UMA network to the UNC 116 via the Internet 146. For example, FIG. 2 is a signal flow diagram depicting the wireless communication device 108 transmitting an IPsec packet 202 to the UNC 116 of the UMA network 204 via the Internet 146. The PDG 118 (UMA security gateway) receives the IPsec packet 202 and decrypts it. The decrypted IPsec packet 204 is then passed to the INC 126.

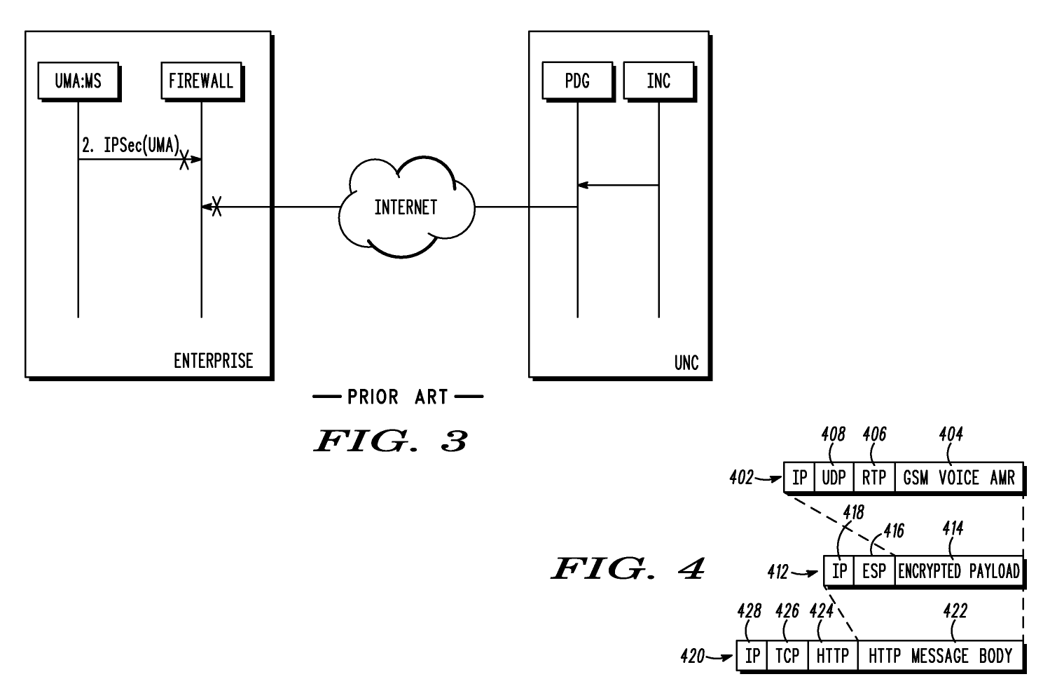

The UMA network 104, as depicted in FIG. 2, is a residential UMA network where a sophisticated firewall is not used. As discussed above, firewalls such as those found in enterprise networks typically use access control to block IPsec packets for outbound traffic and inbound traffic, as shown in FIG. 3. In order to pass IPsec packets through such a firewall, communication system 100 utilizes the UMA communication module 120 of the wireless communication device 108 and the UMA communication proxy 130 communicatively coupled to, or included in, the UNC 116 to prevent the firewall from blocking an IPsec packet. It should be noted that although the present invention is discussed with respect to an enterprise UMA, the present invention is also applicable to any UMA network where IPsec packets are blocked for outbound traffic and inbound traffic.

In one embodiment, the UMA communication module 120 and the UMA Communication Proxy 130 encapsulate an IPsec packet within a network language protocol such as the Hyper Text Transfer Protocol (“HTTP”) (RFC 2616). It should be noted that the present invention is not limited to HTTP protocols, which are used herein as an example only. HTTP protocols are based on various protocols such as SOAP, XML based RPC, and the like as a data transporting means. The HTTP protocol has been used mainly for sending text based data. Therefore, in one embodiment, when sending binary data such as a ZIP file, images, and audio/video, the Multipurpose Internet Mail Extensions (“MIME”) encoded data type is utilized using base64. MIME is a specification that allows non-ASCII messages to be formatted so that the messages can be sent over the Internet.

Base64 is a positional notation that uses a base of 64 and can be represented using only printable ASCII characters. Base64 encoding, which is specified in RFC 2045—MIME (Multipurpose Internet Mail Extensions) uses a 64-character subset (A-Za-z0-9+/) to represent binary data and ‘=’ for padding. Base64 processes data as 24-bit groups, mapping this data to four encoded characters. Base64 is sometimes referred to as 3-to-4 encoding. Each 6 bits of the 24-bit group is used as an index into a mapping table (the base64 alphabet) to obtain a character for the encoded data.

For example, FIG. 4 shows the level of encapsulation of a voice frame, such as an Adaptive Multi-Rate (“AMR”) voice frame used in GSM systems, in an HTTP protocol according to an embodiment of the present invention. This encapsulation enables an IPsec packet to pass through a firewall that normally rejects IPsec packets. Three levels of encapsulation are portrayed in FIG. 4. It should be noted that these three levels are non-limiting examples. The first, or top, layer 402 of encapsulation is of UMA voice packet, which is composed of the raw GSM Voice Frame 404. In this example, the raw GSM Voice Frame 404 is encoded using the AMR codec standard, encapsulated within IETF standardized RTP 406 (Real Time Transport Protocol RFC3550), UDP 408 (User Datagram Protocol RFC768), and IP 410 (Internet Protocol RFC791) for processing within the components 118, 120, 122, 124, and 126 of UNC components 16.

The second, or middle, layer of encapsulation 412 results in the UMA voice packet being encrypted by IPsec, labeled as Encrypted Payload 414. The UMA voice packet is then encapsulated within ESP 416 (Encapsulating Security Payload RFC 4303) and a second layer of IP 418 for processing by the UMA Security Gateway, or PDG, 118.

The third, or bottom, layer of encapsulation 420 takes the IPsec datagram and encodes it using base64 into the HTTP Message Body 422. The HTTP Message Body 422 is then encapsulated within HTTP 424 and an additional layer of TCP 426 and IP 428. The three layers of encapsulation 402, 412, 420 form the complete packet which is then successfully passed by the firewall 110 using deep packet inspection. The firewall 110 inspects the outer IP, TCP, and HTTP headers, but does not inspect inside the HTTP Message Body which is defined by the RFC as a application specific binary format. The firewall 110 passes the complete packet, having found that the packet conforms to the protocol definitions of the source RFCs including being on the well known HTTP open port 80. It should be noted that the above process performed by the firewall 110 is only one example and does not limit the present invention.

In one embodiment, the HTTP protocol is applied by encoding a binary IPSec packet into a base64 format before sending the packet to the PDG 118 of the UNC 116. Also, a proxy component, such as the UMA communication proxy 130 when included in the PDG 118, decodes the base64 format HTTP message into the original IPSec packet, which is then forward to the INC 126.

In one embodiment, the wireless communication device 108, via its UMA communication module 120, sends data such as IPsec data to an HTTP proxy (for example, the UMA communication proxy 130) within the PDG 118 by using one or more HTTP request and HTTP headers defined in RFC2616. For example, HTTP POST (MIME encoded), HTTP POST (URL encoded), GET and PUT can all be used to send data to the UMA communication proxy 130, which can be a HTTP proxy. The data is sent in a key=value pair when using these mechanisms.

In one embodiment, the MIME encoded POST is a good candidate for sending data to the UMA communication proxy 130 in a destination entity such as the UNC 116 when sending large size binary data. The UMA communication module 120 in the wireless device 108 sends IPsec data in an IPsec-Data variable of a message body of an HTTP request message. Table 1 below shows one example of encapsulating IPsec data within a MIME encoded POST message.

TABLE 1
MIME encoded HTTP POST

POST: /mesagehandler.JSP HTTP/1.X
Host: www.uma.com
Content Length: 300
Content-Type: binary
IPSec-Data=base64encoded_IPSec_data

The MIME encoded HTTP POST message given as an example above allows the wireless communication device 108, when in communication with a UMA network, such as UMA network 104, that includes a firewall, such as firewall 110, that blocks IPsec packets, to send an IPsec packet to the UNC 116. It should be noted that the present invention also is applicable to the UNC 116. That is, the communication system 100 also allows UNC 116 to send IPsec packets back to the wireless communication device 108. As discussed above, firewalls generally block inbound IPsec packets as well as outbound IPsec packets. Thus, an IPsec packet received from a UNC 116 is also blocked by the firewall. By using one or more HTTP request and HTTP headers, as discussed above, the communication system 100 allows IPsec packets sent by the UNC 116 to reach the wireless communication device 108 even though a firewall exits in the UMA network 104.

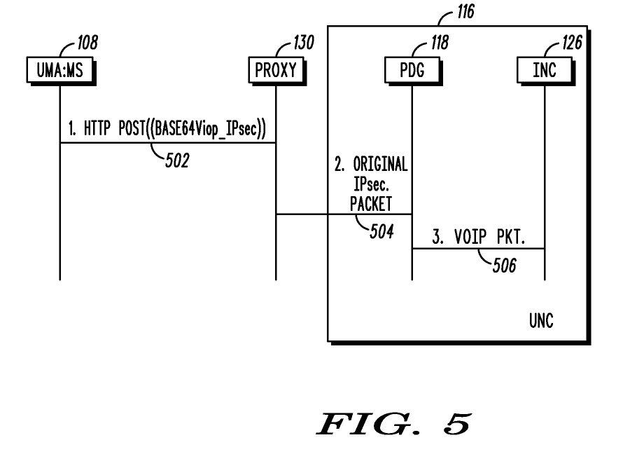

FIG. 5 is a signal flow diagram illustrating a transmission of IPsec data from the wireless communication device 108 to the UNC 116 using the HTTP POST request discussed above according to an embodiment of the present invention. With respect to FIG. 5, the wireless communication device 108 encodes IPSec data into base64 format (via the UMA communication module 120) and sends the encoded IPsec data to the UNC 116 encapsulated within a HTTP POST message 502. The UMA communication proxy module 130, acting as an HTTP proxy, receives the HTTP POST message 502, including the encoded IPsec data, and decodes the base64 encoded the IPSec message into the original IPSec message 504. The proxy sends the original IPsec 504 message to the PDG 118. The PDG 118 then decrypts the IPSec packet 504 into voice data 506 and sends the voice data to the INC 126.

As can be seen from the above discussion the present invention provides an advantageous system wherein a wireless communication device, such as wireless communication device 108, within a UMA network, such as UMA network 104, can send an IPsec packet to a UNC, such as UNC 116. IPsec packets can be sent by the wireless communication device to the UNC by encapsulating the IPsec packets within a network language protocol such as the Hyper Text Transfer Protocol (“HTTP”). This allows the IPsec to pass through a firewall that blocks IPsec packets and provides deep packet inspection to insure traffic sent on well-known ports conforms to the protocol designated for that port.

Wireless Communication Device

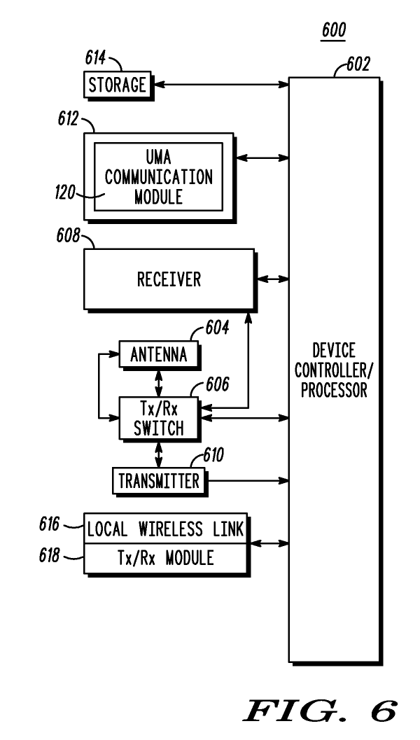

FIG. 6 is a block diagram illustrating a detailed view of the wireless communication device 108 according to an embodiment of the present invention. It is assumed that the reader is familiar with wireless communication devices. To simplify the present discussion, only that portion of a wireless communication device that is relevant to the present invention is discussed.

The wireless communication device 108 operates under the control of a device controller/processor 602 that controls the sending and receiving of wireless communication signals. In receive mode, the device controller 602 electrically couples an antenna 604 through a transmit/receive switch 606 to a receiver 608. The receiver 608 decodes the received signals and provides those decoded signals to the device controller 602.

In transmit mode, the device controller 602 electrically couples the antenna 604, through the transmit/receive switch 606, to a transmitter 610. It should be noted that in one embodiment, the receiver 608 and the transmitter 610 are a dual mode receiver and a dual mode transmitter for receiving/transmitting on wide area and local area networks. In another embodiment a separate receiver and transmitter is used for each of the wide area and local area networks, respectively.

The device controller 602 operates the transmitter and receiver according to instructions stored in a memory 612. These instructions include, for example, a neighbor cell measurement-scheduling algorithm. The memory 612, in one embodiment, also includes the UMA communication module 120 discussed above. The wireless communication device 108, also includes non-volatile storage memory 614 for storing, for example, an application waiting to be executed (not shown) on the wireless communication device. The wireless communication device 108, in this example, also includes an optional local wireless link 616 that allows the wireless communication device 108 to directly communicate with another wireless communication device without using a wireless network (not shown). The optional local wireless link 616, for example, is provided by Bluetooth, Infrared Data Access (IrDA) technologies, or the like.

The optional local wireless link 616 also includes a local wireless link transmit/receive module 618 that allows the wireless communication device 108 to directly communicate with another wireless communication device such as wireless communication devices communicatively coupled to personal computers, workstations, and the like. It should be noted that the optional local wireless link 616 and the local wireless link transmit/receive module 618 can be used to communicated within the UMA network 204 as discussed above.

Information Processing System

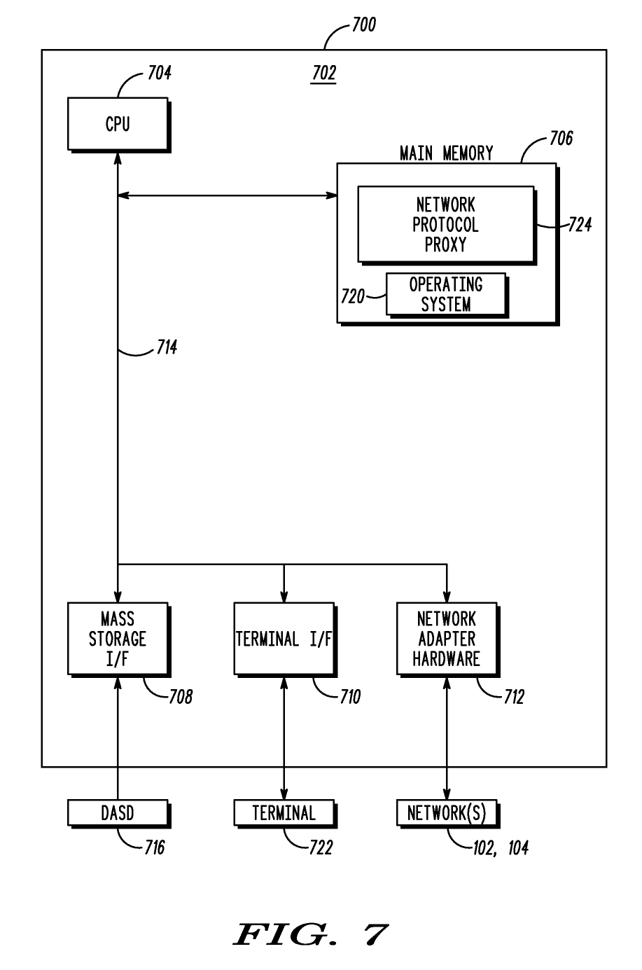

FIG. 7 is a block diagram illustrating a detailed view of an information processing system 700, preferably a UNC such as UNC 116, according to an embodiment of the present invention. It is assumed that the reader is familiar with information processing systems in general. To simplify the present discussion, only that portion of an information processing system that is relevant to the present invention is discussed.

The information processing system 700, in one embodiment, is based upon a suitably configured processing system adapted to implement the exemplary embodiment of the present invention. Any suitably configured processing system is similarly able to be used as the information processing system 700 by embodiments of the present invention, for example, a personal computer, workstation, or the like. It should be noted that the following discussion is also applicable to the UMA communication proxy 130 in an embodiment where the communication proxy 130 is resides outside of the information processing system 700.

The information processing system 700 includes a computer 702. The computer 702 has a processor 704 that is communicatively connected to a main memory 706 (e.g., volatile memory), non-volatile storage interface 708, a terminal interface 710, network adapter hardware 712, and a system bus 714 interconnects these system components. The non-volatile storage interface 708 is used to connect mass storage devices, such as data storage device 716, to the information processing system 700. One specific type of data storage device is a data storage device configured to support, for example, NTFS type file system operations.

The main memory 706 includes, among other things, a network protocol proxy 724, preferably a UMA communication proxy such as UMA communication proxy 130, which has been discussed above in greater detail. It should be noted that one or more of the components 118, 120, 122, 124, and 126 discussed above with respect to the UNC 116 in FIG. 1 have not been included within this discussion for simplicity. Although illustrated as concurrently resident in the main memory 706, it is clear that respective components of the main memory 706 are not required to be completely resident in the main memory 706 at all times or even at the same time. For example, the network protocol proxy 724 can be implemented as hardware within a UNC, such as UNC 116, or can be implemented within another component, such as components 118, 120, 122, 124, and 126, within the UNC. It should be noted that the network protocol proxy 724 can also be a separate component from the information processing system 700, for example, residing outside of, and being communicatively coupled to, a UNC.

Terminal interface 710 is used to directly connect one or more terminals 722 to computer 702 to provide a user interface to the computer 702. These terminals 722, which are able to be non-intelligent or fully programmable workstations, are used to allow system administrators and users to communicate with the thin client. The terminal 722 is also able to include user interface and peripheral devices that are connected to computer 702 and controlled by terminal interface hardware included in the terminal I/F 710 that includes video adapters and interfaces for keyboards, pointing devices, and the like. In one embodiment, the terminal interface 710 can be a man/machine interface.

An operating system 720, according to an embodiment, can be included in the main memory and is a suitable multitasking operating system such as the Linux, UNIX, Windows XP, and Windows Server 2003 operating system. Embodiments of the present invention are able to use any other suitable operating system, or kernel, or other suitable control software. The network adapter hardware 712 is used to provide an interface to a network such as the Internet 146, the circuit services network 102, or the like. Embodiments of the present invention are able to be adapted to work with any data communications connections including present day analog and/or digital techniques or via a future networking mechanism.

Process Of Transmitting Network Language Protocol Encoded IPsec Packets

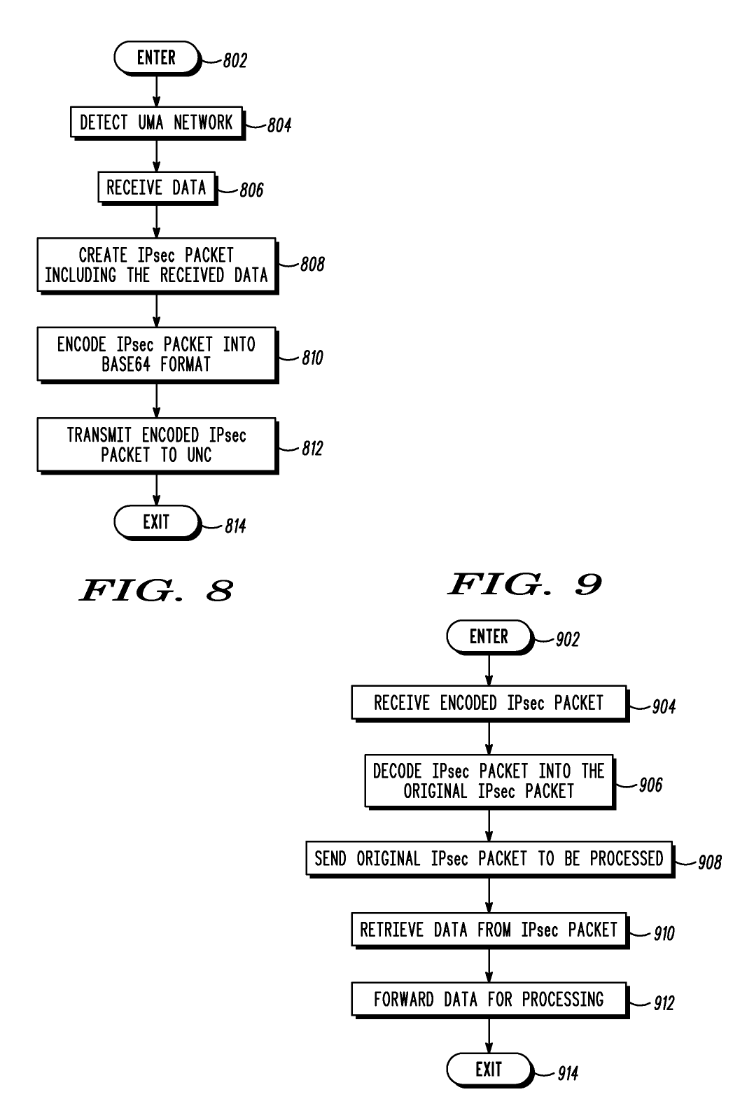

FIG. 8 is a logic flow diagram illustrating a process of encapsulating an IPsec packet within a network language protocol for transmitting an IPsec packet to the UNC 116 in the UMA network 104 according to an embodiment of the present invention. The logic flow diagram of FIG. 8 begins at step 802 and flows directly to step 804. The wireless communication device 108, at step 804, detects the UMA network 104. The wireless communication device 108, at step 806, receives data from a user such as voice data. The wireless communication device 108, at step 808, creates an IPsec packet including the received data. The IPsec packet, at step 810, is encoded into a base64 format as discussed above. The encoded IPsec packet, at step 812, is transmitted to the UNC 116 of the UMA network 104. The logic flow then ends at step 814. It should be noted that the above process is also applicable to a UNC 116 when a UNC 116 transmits an IPsec packet to the wireless communication device 108 via the UMA network.

Process Of Receiving Network Language Protocol Encoded IPsec Packets

FIG. 9 is a logic flow diagram illustrating a process receiving a network language protocol encoded IPsec packet at the UNC 116 in the UMA network 104 according to an embodiment of the present invention. The logic flow diagram of FIG. 9 begins at step 902 and flows directly to step 904. The UMA communication proxy 130 within the UNC 116, at step 904, receives an encoded IPsec packet transmitted by the wireless communication device 108. The UMA communication proxy 130, at step 906, decodes the IPsec packet into the original IPsec packet.

The UMA communication proxy 130, at step 908, transmits the original IPsec packet to the PDG 118. The PDG 118, at step 910, retrieves data such as a voice packet from the original IPsec packet. The PDG 118, at step 912, forwards the retrieved data to the INC 126 for further processing. The logic flow then ends at step 914.

Detailed Process Of A Wireless Device Transmitting Packets In A UMA Network

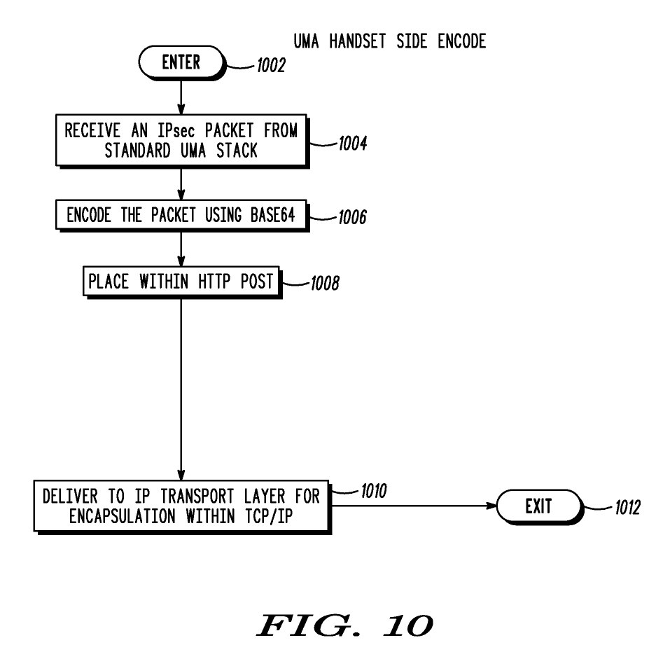

FIG. 10 is a logic flow diagram illustrating a process whereby the wireless communication device 108 encapsulates an IPsec packet within a network language protocol for transmitting an IPsec packet to the UNC 116 in the UMA network 104 according to an embodiment of the present invention. The logic flow flow diagram of FIG. 10 begins at step 1002 and flows directly to step 1004. The wireless communication device 108, at step 1004, received an IPSec packet from a standard UMA stack. The wireless communication device 108, at step 1006, encodes the packet using base64. At step 1008, the wireless communication device 108 places the packet, which has been encoded in base64, within an HTTP Post message. The wireless communication device 108, at step 1010, delivers the HTTP Post message to an IP transport layer for encapsulation within TCP/IP. The control flow ends at step 1012.

Detailed Process Of Receiving Network Language Protocol Encoded IPsec Packets

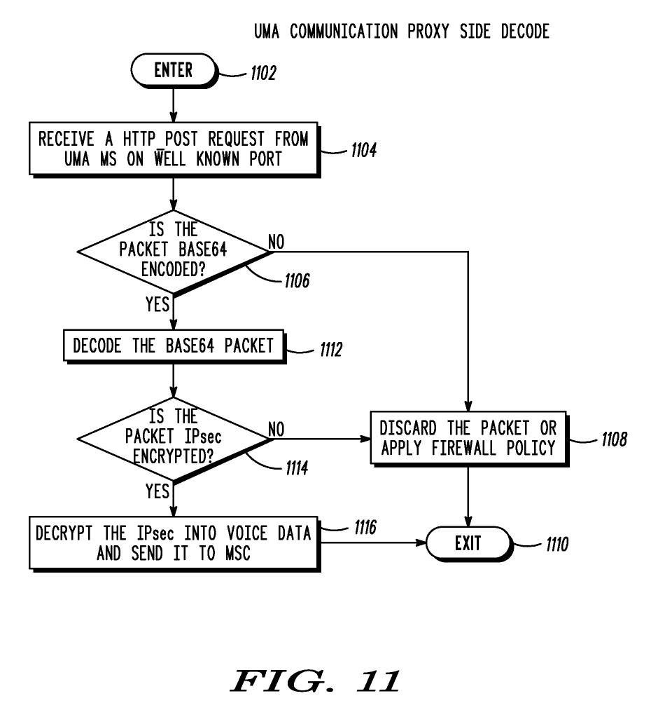

FIG. 11 is a logic flow diagram illustrating a process whereby UNC 116 receives and processes a network language protocol encoded IPsec packet according to an embodiment of the present invention. The logic flow diagram of FIG. 11 begins at step 1102 and flows directly to step 1104. The UNC 116, at step 1104, receives an HTTP_POST request from the wireless communication device 108 on a well known port. The UNC 116, at step 1106, determines if the received packet is base64 encoded. If the result of this determination is negative, the UNC 116 proceeds to step 1108 and discards the packet or applies a firewall policy. The logic flow then ends at step 1110.

If the result of the determination at step 1106 is positive, the UNC 116 proceeds to step 1112 and decodes the base64 packet. The UNC 116, at step 1114, determines if the decoded packet is IPSec encrypted. If the decoded packet is not IPSec encrypted, the logic flow proceeds to step 1108, which step is discussed above. If the decoded packet is IPSec encrypted, the UNC 116 proceeds to step 1116 where the UNC decrypts the IPSec into voice data and sends the voice data to the MSC 140. The logic flow then ends at step 1110.

Detailed Process Of A UNC Transmitting Packets To A Wireless Device In a UMA network

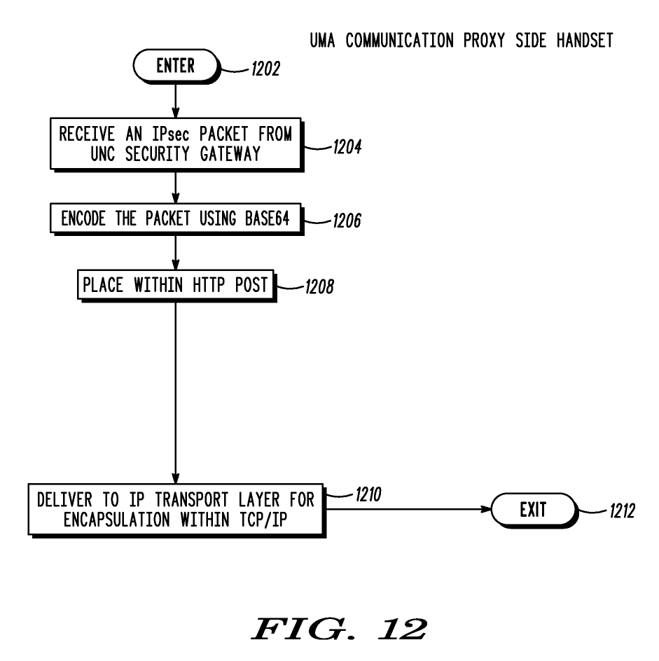

FIG. 12 is a logic flow diagram illustrating a process whereby the UNC 116 encapsulates an IPsec packet within a network language protocol for transmitting the IPsec packet to the wireless communication device 108 according to an embodiment of the present invention. The logic flow diagram of FIG. 12 begins at step 1202 and flows directly to step 1204. The UNC 116, at step 1204, received an IPSec packet from the UNC security gateway (PDG) 118. The UNC 116, at step 1206, encodes the packet using base64. At step 1208, the packet that has been encoded in base64 is placed within an HTTP Post message. The UNC 116, at step 1210, delivers the HTTP Post message to an IP transport layer for encapsulation within TCP/IP. The control flow ends at step 1212.

Detailed Process Of A Wireless Communication Device Receiving Network Language Protocol Encoded IPsec Packets

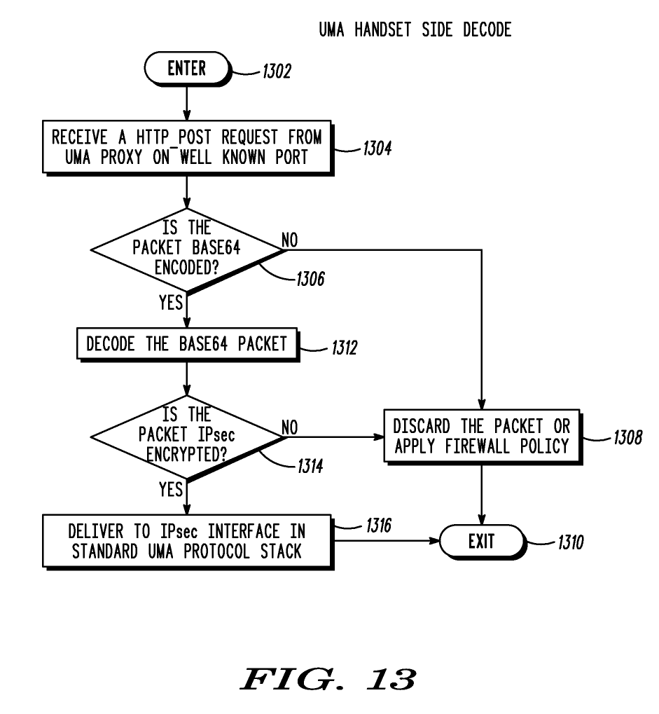

FIG. 13 is a logic flow diagram illustrating a process whereby the wireless communication device 108 receives a network language protocol encoded IPsec packet from the UNC 116 according to an embodiment of the present invention. The logic flow diagram of FIG. 13 begins at step 1302 and flows directly to step 1304. The wireless communication device 108, at step 1304, receives an HTTP_POST request from the UNC 116 or UMA communication proxy 130 on a well known port. The wireless communication device 108, at step 1306, determines if the received packet is base64 encoded. If the received packet is not base64 encoded, the wireless device 108 proceeds to step 1308 and discards the packet or applies a firewall policy. The logic flow then ends at step 1310.

If the received packet is base64 encoded, the wireless communication device 108 proceeds to step 1312 and decodes the base64 packet. The wireless device 108, at step 1314, determines if the decoded packet is IPSec encrypted. If the decoded packet is not IPSec encrypted, the logic flow proceeds to step 1308, which step is discussed above. If the decoded packet is IPSec encrypted, the wireless communication device 108 proceeds to step 1316 and decrypts the IPSec into voice data and sends the voice data to a UMA Standard Stack. The logic flow then ends at step 1310.

### Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method, with a wireless communication device, for at least one of transmitting and receiving data over an unlicensed mobile access network, the method comprising:
establishing a connection with an unlicensed mobile access network;
receiving data from a user to be transmitted over the unlicensed mobile access network;
creating at least one IPsec packet including the data received from the user;
encapsulating the IPsec packet within a network language protocol; and
transmitting the encapsulated IPsec packet to an unlicensed network controller within the unlicensed mobile access network.

2. The method of claim 1, wherein the encapsulating further includes encoding the IPsec packet into a base64 format.

3. The method of claim 1, wherein the transmitting further includes transmitting the encapsulated IPsec packet within a message body of a network protocol language request message.

4. The method of claim 1, wherein the received data is voice data.

5. The method of claim 1, wherein the network language protocol is a Hyper Text Transfer protocol.

6. The method of claim 1, wherein the encapsulating further comprises encapsulating the IPsec packet within a network language protocol formatted in a Multipurpose Internet Mail Extensions format.

7. The method of claim 3, wherein the network protocol language request message is a Hyper Text Transfer protocol POST message.

8. The method of claim 1, further comprising:
receiving an encapsulated IPsec packet from an Unlicensed Mobile Access network component, wherein the IPsec packet is encapsulated within a network language protocol;
transforming the encapsulated IPsec packet into its original form; and
retrieving data from the IPsec packet in original form.

9. A method, with an information processing system, for managing IPsec packets within an unlicensed mobile access network, the method comprising:
receiving an encapsulated IPsec packet from a wireless device, wherein the IPsec packet is encapsulated within a network language protocol;
transforming the encapsulated IPsec packet into its original form; and
retrieving data from the IPsec packet in original form.

10. The method of claim 9 wherein the transforming further comprises:
determining, in response to receiving the encapsulated IPsec packet, if the encapsulated IPsec packet is encoded in a base64 format;
applying, in response to the encapsulated IPsec packet failing to be base64 encoded, a firewall policy to the encapsulated IPsec packet;
determining, in response to the encapsulated IPsec packet being base64 encoded, if the encapsulated IPsec is encrypted; and
decrypting, in response to the encapsulated IPsec being, encrypted the encapsulated IPsec packet.

11. The method of claim 9, further comprising:
receiving an IPsec packet from a security gateway;
encoding the IPsec packet;
encapsulating the IPsec packet within a network language protocol; and
transmitting the encapsulated IPsec packet the wireless device.

12. A wireless communication device comprising:
a processor; and
a memory communicatively coupled to the processor and comprising an unlicensed mobile access network communication module that is adapted to:
establish a connection with an unlicensed mobile access network;
receive data from a user to be transmitted over the unlicensed mobile access network;
create at least one IPsec packet including the data received from the user;
encapsulate the IPsec packet within a network language protocol; and
transmit the encapsulated IPsec packet to an unlicensed network controller within the unlicensed mobile access network.

13. The wireless communication device of claim 12, wherein the encapsulating further includes encoding the IPsec packet into a base64 format.

14. The wireless communication device of claim 12, wherein the transmitting further includes transmitting the encapsulated IPsec packet within a message body of a network protocol language request message.

15. The wireless communication device of claim 14, wherein the network protocol language request message is a Hyper Text Transfer Protocol POST message.

16. The wireless communication device of claim 12, wherein the received data is voice data.

17. The wireless communication device of claim 12, where in the network language protocol is a Hyper Text Transfer Protocol.

18. The wireless communication device of claim 12, wherein the encapsulating further comprises:
encapsulating the IPsec packet within a network language protocol formatted in a Multipurpose Internet Mail Extensions format.

19. The wireless communication device of claim 12, wherein the unlicensed mobile access network communication module is further adapted to:
receive an encapsulated IPsec packet from an Unlicensed Mobile Access network component, wherein the IPsec packet is encapsulated within a network language protocol;
transform the encapsulated IPsec packet into its original form; and
retrieve data from the IPsec packet in original form.
